(19) United States
(12) Patent Application Publication
(10) Pub. No.: US 2023/0232753 A1
(43) Pub. Date: Jul. 27, 2023

(54) APPARATUS FOR PROVIDING A ROOT AIR GAP

(71) Applicant: Local Bounti Operating Company, LLC, Hamilton, MT (US)

(72) Inventors: Ryan SWEENEY, Hamilton, MT (US); Bryan B. NGUYEN, Garland, TX (US); Ari HOROWITZ, Brooklyn, NY (US)

(73) Assignee: Local Bounti Operating Company, LLC, Hamilton, MT (US)

(21) Appl. No.: 18/148,531

(22) Filed: Dec. 30, 2022

Related U.S. Application Data
(60) Provisional application No. 63/302,211, filed on Jan. 24, 2022.

(51) Int. Cl. A01G 9/029

(52) U.S. Cl. CPC A01G 9/0297

(57) ABSTRACT

A plant tray may include multiple plant cells. The plant cells may suspend the plants above a nutrient solution, creating an air gap between the plants and the nutrients. Roots may grow in the air gap. Walls may surround the air gap, in order to prevent or reduce air pruning of the roots. The climate of the air gap or air gaps may be controlled and modified independent of the surrounding climate. Some embodiments may use an inserted disk or plate to separate the plants or plant substrate from the air gap, while others may implement a cup or hourglass shaped cells with a chokepoint. Each disk, cup, or hourglass shaped cell may be configured such that the roots of the plant pass through to the air gap while supporting or securing the plant substrate above the air gap.

### FIELD

An exemplary embodiment relates to the field of agriculture.

### BACKGROUND

Controlled environment agriculture (CEA) provides many advantages over traditional or conventional agricultural methods. For example, CEA may require a smaller footprint while producing a higher yield. The use of a controlled environment can allow variables such as light and temperature to be precisely specified. However, CEA still faces a number of challenges. For example, a risk of crop failure and a high risk of disease and virus outbreak still exists.

While CEA may improve growing speed when compared to traditional farms, improvements to expedite yield are still sought after. For example, providing the correct balance of nutrients may expedite growth of that plant, however, that may be specific to each varietal. Light intensity and temperature can also be selected to promote plant growth.

### SUMMARY

According to at least one exemplary embodiment, a system and apparatus for optimizing growth of plant roots may be shown and described. An exemplary embodiment may provide a tray for holding growing plants which creates an air gap between the plant plug and the nutrient solution. For example, an embodiment may be implemented with any method of plant production, such as a deep-water culture (DWC), a nutrient film technique (NFT), an ebb and flow sub-irrigation system, aeroponics, or any other contemplated method. In a DWC system, plants are suspended in a solution of nutrient-rich oxygenated water solution. Plants may be placed in a tray which allows the roots to pass through to the underlying nutrient solution. The roots absorb water and nutrients by being completely submerged in the solution. An exemplary embodiment may suspend the plants above the nutrient solution, leaving an air gap between the bottom of the plant and the top of the nutrient solution. The air gap may include walls or a supportive skirt around the perimeter in order to protect the roots from air pruning. Air pruning typically occurs when roots are exposed to air in the absence of high humidity, causing the exposed roots to die back or otherwise stunting root growth. By providing a protective perimeter around the plant roots, an exemplary embodiment may protect the growing roots from air pruning by providing a protected environment around them. In an exemplary embodiment, a microclimate may be created around the plant roots.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a traditional prior art seedling tray.

FIG. 2A is an exemplary embodiment of a seedling tray configured to receive plant cups for creating an air gap.

FIG. 2B is an exploded view of an exemplary seedling tray and plant cup configuration.

FIG. 3A is an exemplary embodiment of a seedling tray with disks or plates for creating an air gap.

FIG. 3B is an exploded view of an exemplary seedling tray and disk configuration.

FIG. 4 is an exemplary embodiment of a seedling tray with hourglass shaped cells configured for creating an air gap.

FIG. 5 is a side view of an exemplary seedling tray configured for creating an air gap.

FIG. 6 is a bottom view of an exemplary seedling tray.

FIG. 7 is a top view of an exemplary seedling tray.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

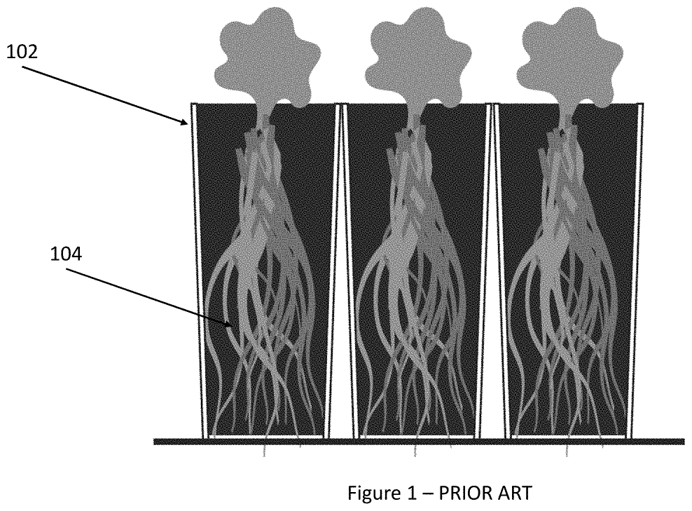

FIG. 1 may illustrate a typical seedling tray in the prior art. Typically, the seedling tray may include multiple cells 102 for holding plants. The plant roots 104 grow within the cells 102. Some sort of growing medium or substrate may be placed in each cell.

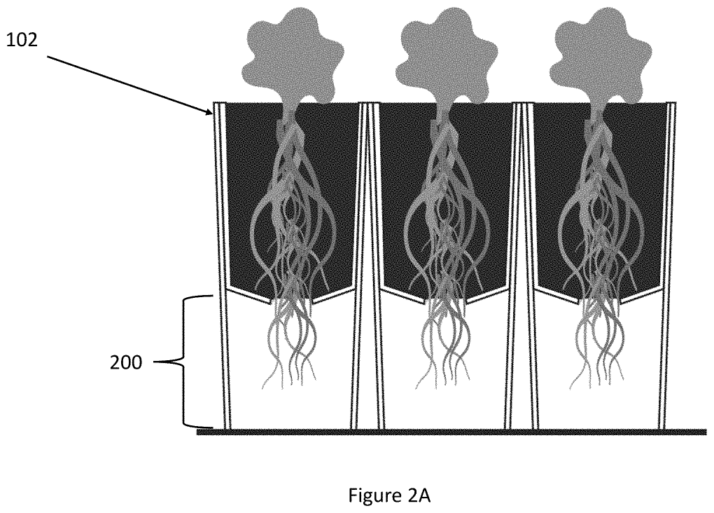

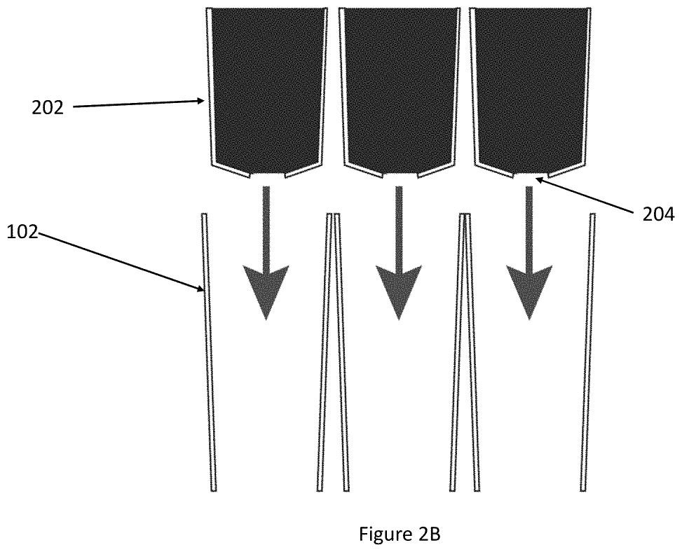

FIG. 2A may illustrate an exemplary embodiment of a seedling tray for holding plants, where the roots are suspended in an air gap 200. As illustrated in FIG. 2A and FIG. 2B, the tray cells 102 are sized to receive plant pods or cups 202 which hold the plants. The plant cups 202 may be removable from the tray cells 102. The plant cups 202 may be sized such that they are smaller and/or shorter than the walls of the tray cells 102. The plant cups 202 may have an open bottom 204 for allowing the plant roots to pass through the cup 202 into the open air gap 200. The air gap 200 may form a microclimate for the roots to grow in. For example, variables (such as humidity) in the microclimate may be controlled in order to optimize the growth of the tap roots. A higher humidity within the microclimate may prevent air pruning of the roots. A growing medium or substrate may be placed in the plant cups 202, but the roots may extend past the growing medium into the air gap 200 via the hole in the open bottom 204 of the cup. The microclimate may be configured based on the system. For example, an embodiment implementing an NFT system may require a different air gap size than a DWC system. The watering method or facility may require differently sized air gaps or microclimates. It may also be contemplated that the air gap may be modified based on the plant type or phase of growth.

In an exemplary embodiment, the tap root and lateral roots may be protected by the air gap. The tap root is essential to appropriate hormonal signaling between shoot apical meristem and root apical meristem. Protecting the tap root during the elongation process via the microclimate created of appropriate temperature and humidity may ensure that the plant does not go through shock. Plant shock may occur when plants are transplanted into a new environment, however, the protection of the tap root may sustain a constant environment, thus protecting against plant shock. Protection of the lateral roots may allow for better immediate hydration following transplant also due to the microclimate, eliminating the need for plant hardening following a transplant. Additionally, the root extension may create a capillary system that keeps the substrate hydrated, thus reducing the need for overhead irrigation in the stages following the transplant. The plant plug may be kept smaller due to the extension of the roots. A smaller plant plug allows an increased planting density, thus allowing for an increase in total number of plants per facility. Less fertilizer may need to be used due to the smaller plug. The smaller plug may also facilitate the creation of a microclimate specific to the plant, with increased humidity in order to avoid root dehydration and air pruning.

The protection of lateral roots during early-stage growth may protect the plant during mechanized high throughput transplanting. If only the taproot is protected when a mechanical hand or transplanting mechanism were to grab the plant, the mechanism might not be able to successfully grasp both media and plant together. The lateral roots may assist in maintaining the structure of the plant plug during transfer, such as from a tray to a raft or gutter. Without significant lateral roots, the media may fall away from the plant. The plant, when placed in either DWC or NFT systems with the media, may not have the necessary physical support of the media to hold itself upright and instead may collapse, thus potentially rotting and dying.

Depending on the plant varietal and its need for space to avoid crowding, a different tray may be chosen with greater spacing. By identifying how the air gap design can be implemented in any tray format as either a tray modification or the addition of an insert, an exemplary system or apparatus may be adjustable to both the varietal as well as technological needs.

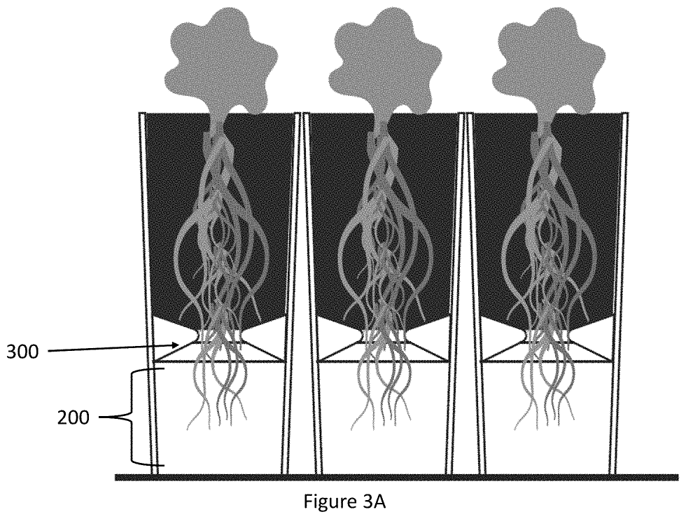

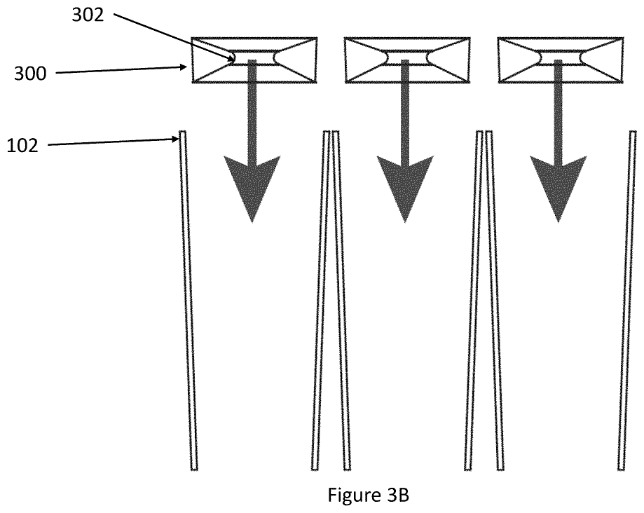

FIGS. 3A and 3B may illustrate an alternative exemplary embodiment of a seedling tray. The seedling tray in FIGS. 3A and 3B may implement a disk or plate 300 in each tray cell 102. The disk 300 may support the plant as well as the growing medium. The disk 300 may include a hole or aperture 302 which allows the plant roots to pass through into the air gap 200. The size of the air gap 200 may be adjusted based on the placement of the disk 300. For example, a larger air gap may be created by placing the disk higher along the tray cell 102. It may be contemplated that the tray cells 102 contain notches for receiving and securing the disk 300. In an exemplary embodiment, the disk 300 may be placed into the tray cells 102 which may narrow or taper such that the disk 300 is secured by friction to the walls of the tray cell 102. As shown in FIG. 3B, each disk 300 may be removable or placed into the cell 102. It may be contemplated that the same tray may implement both the disks 300 in some cells and the cups 202 in other cells.

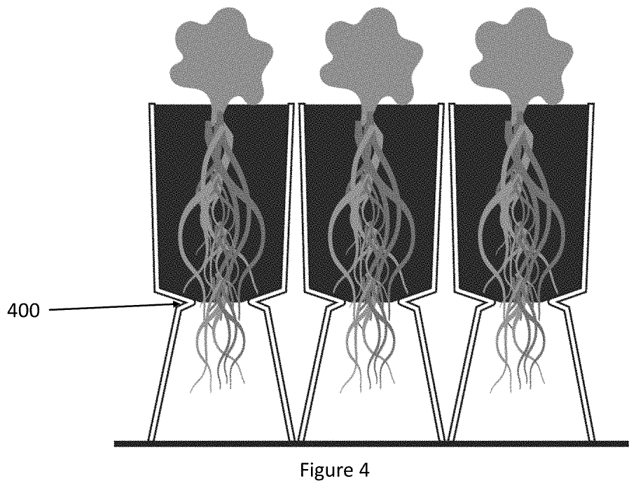

Referring now to FIG. 4, FIG. 4 may illustrate an alternative embodiment of a plant tray. This exemplary plant tray may include multiple cells 102 which are shaped to create a choke point 400. The hourglass shaped cells may allow the choke point 400 to act similar to the disk 300 or cups 202 previously described. For example, the choke point 400 may suspend the growing substrate while allowing plant roots to pass through. Thus, the bottom portion of the hourglass shaped cells may create an airgap in which the plant roots can reach. The top portion of the hourglass shaped cells can hold the plant substrate or growing medium. A plant tray may include multiple hourglass shaped cells.

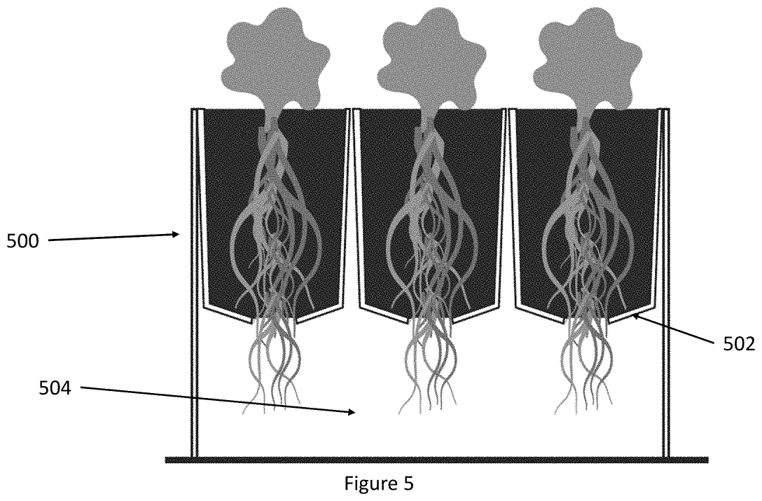

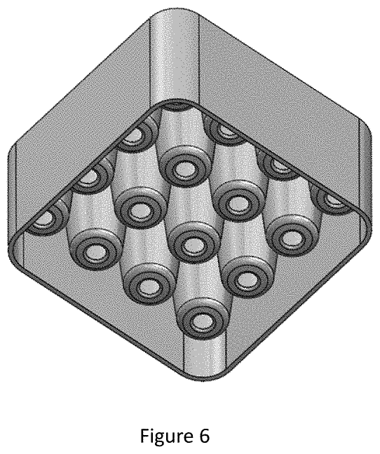

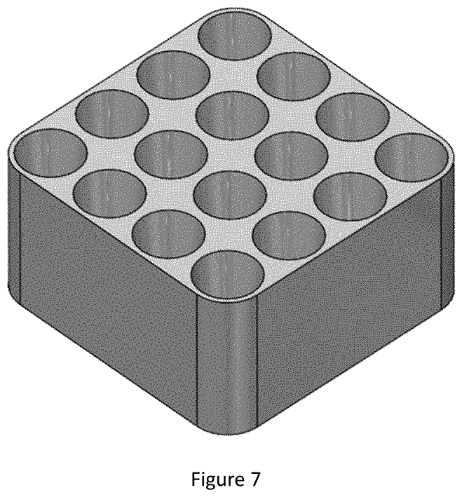

Referring now to FIG. 5, FIG. 5 may illustrate another exemplary embodiment of a plant tray. This exemplary embodiment may implement multiple plant cells 500 which have a shorter bottom 502. The bottom of each cell 500 may include an opening that allows the plant roots to pass through to an air gap 504. Each exemplary tray may include walls around the perimeter of the group of cells, as opposed to walls around each cell. The air gap 504 may receive the roots of multiple plants. It may be contemplated that a microclimate may be created within the air gap 504. For example, the humidity, temperature, and other environmental factors may be controlled inside the air gap 504. The microclimate of the air gap 504 may be different than the climate of the remainder of the agricultural system, in order to promote root growth. For example, it may be contemplated that the root microclimate is kept at a higher humidity than the rest of the agricultural system. By increasing the humidity in the microclimate, the roots may be encouraged to continue growing downwards and air pruning can be reduced or prevented. Tap roots growing within the air gap may grow at faster rates. The air gap may further optimize the growth of the tap roots by directing their growth according to the needs of the shape of the tray or the needs of the facility. For example, it may be contemplated that the plants may be transplanted to a subsequent growing phase, where the tap roots are directly submerged in a nutrient solution. By optimizing the length of the roots using the air gap, plant growth in the subsequent phase may be expedited due to the larger surface area of the roots submerged in the nutrients. FIGS. 6 and 7 may show a three-dimensional illustration of an exemplary tray.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. A system for facilitating the growth of a crop, the system comprising:
a pod comprising a crop substrate and a partially opened bottom, wherein the partially opened bottom is constricted towards a center point of the pod to allow crop roots to pass through outside and below the pod while retaining the crop substrate within the pod;
a tray comprising a plurality of cells, wherein each cell is sized to receive one pod, and wherein the pods are suspended within the cells,
an open-air gap between the partially opened bottom of the pods and a body or flow of water or nutrient-water solution below a bottom plane of the tray, wherein the open-air gap is delimited by at least two sides of the tray, and the roots extend through the open-air gap into the water.

2. The system of claim 1, wherein the at least two sides of the tray are sized to raise the pods suspended within the cells above the body of water.

3. The system of claim 2, further comprising one or more environmental controls directed towards the open-air gap capable of configuring a microclimate within the open-air gap to adjust temperature and/or humidity.

4. The system of claim 3, wherein the microclimate within the open-air gap is different from a climate above the pods.

5. A method for facilitating growth of a crop, the method comprising:
placing a crop into a pod, the pod comprising a partially opened bottom;
passing roots of the crop through the partially opened bottom of the pod;
suspending the pod within a cell, such that the roots of the crop are suspended within an open-air gap between the partially opened bottom of the pod and a bottom surface of the cell;
adjusting a humidity of the open-air gap, wherein the open-air gap of the cell comprises a microclimate adjusted independently of a climate above the crop.

6. The method of claim 5, wherein the cell is within a tray comprising a plurality of cells configured to receive a plurality of pods, wherein the open-air gap is delimited by walls of the tray.

7. The method of claim 6, wherein the microclimate within the open-air gap of the tray is adjusted independently of an open-air gap of an adjacent tray.

8. The method of claim 6, further comprising transplanting the pod from the tray to a subsequent tray, wherein cells within the subsequent tray are less densely arranged than the cells in the tray.

9. The method of claim 8, wherein the crop roots are entirely submerged in a nutrient solution in the subsequent tray.

10. The method of claim 6, wherein adjusting the humidity further comprises increasing the humidity in the microclimate above a humidity level of the climate above the crop.
